(19) United States
(12) Patent Application Publication
(10) Pub. No.: US 2026/0008349 A1
(43) Pub. Date: Jan. 8, 2026

(54) METHODS AND DEVICES FOR CONTROLLING AN ELECTRIC VEHICLE

(71) Applicant: Harold Glen Alexander, Smyrna, GA (US)

(72) Inventor: Harold Glen Alexander, Smyrna, GA (US)

(21) Appl. No.: 18/762,213

(22) Filed: Jul. 2, 2024

(51) Int. Cl. B60L 3/12; B60L 58/16

(52) U.S. Cl. CPC B60L 3/12; B60L 58/16

(57) ABSTRACT

A system, methods, and devices are disclosed for managing and controlling vehicles that have undergone conversion from gasoline power to another type of power, such as electrical power. An Electric Vehicle Interface Controller (EVIC) system may provide real-time monitoring of vehicle parameters, such as speed, battery status, electric motor performance, and Bluetooth connectivity. The EVIC system may interface with a blockchain network to maintain records of conversion and maintenance data, such as total miles driven, certified parts installations, and certified mechanics' activities. The EVIC system may manage battery life. The EVIC system may manage battery cell health, detecting and rerouting power around malfunctioning cells to ensure safe vehicle operation. The EVIC system may provide remote diagnostics capabilities via a mobile application, optimizing battery charging, and offering temperature-based battery maintenance recommendations.

### BACKGROUND

The present disclosure relates to, among other things, a device capable of controlling an electric vehicle, e.g., a gasoline-powered vehicle converted to electric power.

The automotive industry is witnessing a profound shift towards sustainability and environmental responsibility, with an increasing emphasis on electric vehicles (EVs). This transition is accompanied by a growing demand for converting traditional gasoline-powered vehicles into electric ones, driven by the desire to reduce emissions and embrace clean energy alternatives. However, this transformation presents a unique set of challenges, including the need for comprehensive control and monitoring systems tailored to the specific requirements of converted EVs.

Accordingly, there is a need for an advanced control unit that seamlessly integrates with vehicles recently converted from gasoline to electric power.

### SUMMARY

An Electric Vehicle Interface Controller system (EVIC) is disclosed, addressing the need for an advanced control unit that seamlessly integrates with vehicles recently converted from gasoline to electric power. As an example the EVIC system may be configured to generate health scores associated with the one or more battery cells used to generate electric power, manage battery cell usage, communicate with a blockchain network to store conversion and maintenance information on a distributed ledger, employ a machine learning model to provide recommendations associated with battery cell usage, battery cell temperature, battery cell rerouting, and real-time driving scenarios, among other useful features. Providing the above functionality necessitates a multidisciplinary approach, uniting expertise in embedded systems, software engineering, cybersecurity, and electrical engineering, paving the way for a seamless transition from internal combustion engines to electric powertrains across diverse vehicle types.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

FIG. 1 illustrates an exemplary environment for a converted electric vehicle.

FIG. 2 illustrates an exemplary architecture for an EVIC System.

FIG. 3 illustrates an exemplary method for a universal electric vehicle operating system.

FIG. 4 illustrates an exemplary method for a user interface display in a converted electric vehicle.

FIG. 5 illustrates an exemplary method for a battery management system in a converted electric vehicle.

FIG. 6 illustrates an exemplary method for monitoring and updating information associated with an EVIC system onto a distributed digital ledger.

FIG. 7 illustrates an exemplary method for monitoring and updating information associated with one or more battery cells in an EVIC system.

FIG. 8 is an exemplary block diagram representing a computer system in which aspects of the methods and systems disclosed herein or portions thereof may be incorporated.

FIG. 9 shows an example representation of a health score.

### DETAILED DESCRIPTION

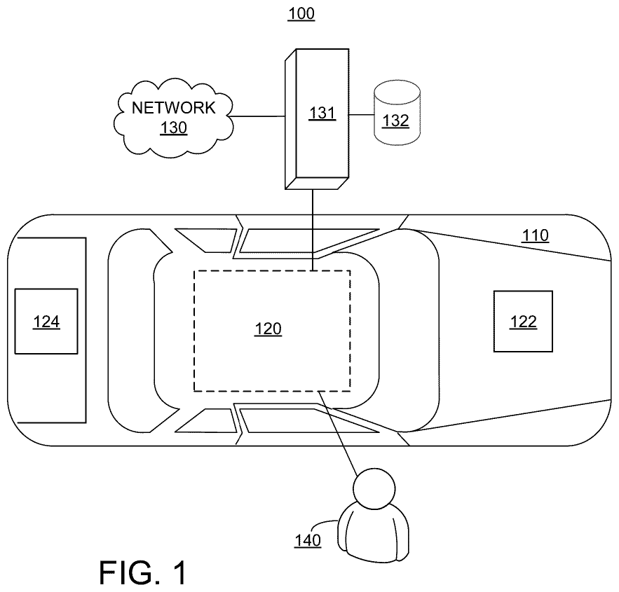

Description will now be given with reference to the attached FIGS. 1-9. It should be understood that these figures are exemplary in nature and in no way serve to limit the scope of the invention, which is defined by the claims appearing hereinbelow. Moreover, the present disclosure is not limited in any way to the examples, which can be applicable in various forms, as appreciated by one skilled in the art. Therefore, it is to be understood that any terms, phrases, structural and functional details, disclosed herein are merely a basis for the claims and as a representative for teaching one skilled in the art to variously employ the present disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present disclosure, exemplary methods and materials are now described.

It must be noted that as used herein and in the appended claims, the singular forms “a,” “an,” and “the” include plural referents unless the context clearly dictates otherwise. Thus, for example, reference to “a stimulus” includes a plurality of such stimuli and reference to “the signal” includes reference to one or more signals and equivalents thereof as known to those skilled in the art, and so forth. In addition, the use of the word “or” is generally used inclusively unless otherwise provided herein.

One skilled in the art will appreciate further features and advantages based on the described examples. Accordingly, the disclosure is not to be limited by what has been particularly shown and described, except as indicated by the appended claims. Further, although at least one series of steps are presented as an exemplary method of practicing one or more examples described herein, it will be appreciated by those skilled in the art that the steps identified may be practiced in any order that is practicable, including without limitation the omission of one or more steps.

To execute one or more tasks seamlessly, the EVIC system may utilize a custom Linux-based operating system that interfaces with the vehicle's Controller Arca Network (CAN) bus, collecting and converting data for display on an LED screen. For example, the EVIC system may be configured to provide drivers with essential real-time information and functionalities, ensuring a smooth and reliable transition to electric mobility. The EVIC system's functions may encompass displaying, through a user interface of the LED screen, vehicle metrics such as speed, battery status, remaining battery life, electric motor rotation and status, and facilitating Bluetooth connectivity.

Additionally, the EVIC system may utilize blockchain technology (e.g., or other distributed database), enabling the secure registration of vital data, including total miles driven by the converted electric vehicle, a comprehensive inventory of certified parts used in the conversion process, and a verified list of certified mechanics involved in installations. The EVIC system may connect to a central database housing information about certified mechanics. For example, the EVIC system may be configured to only allow mechanics with the requisite certifications access to the system to install certified parts, guaranteeing high-quality standards in the conversion process and continued maintenance of the vehicle. To ensure certified parts are installed in the converted electric vehicle, the EVIC system may cross-reference the mechanic and/or the parts to be installed via the blockchain network or a database connected to the EVIC system. This blockchain integration may ensure transparency and trust in the conversion process and continued maintenance of the vehicle, contributing to the safety and reliability of converted EVs. The recording of data, such as the vehicle's odometer reading and the like, onto the distributed ledger of a blockchain network may be utilized to prevent fraud and theft. The integrated blockchain network may be updated in real-time upon installation or replacement of components. The blockchain network may be a custom blockchain network designed for electric vehicles or other blockchain networks known in the art.

The EVIC system may generate a health score associated with the vehicle based on the total miles driven, certified parts installed, battery status, weather conditions the battery has been exposed to, other information associated with the condition of the vehicle, or any combination thereof. The health score may be stored on the distributed ledger of the blockchain network to ensure the integrity of the health score and prevent tampering. If the health score is stored on the blockchain network, this information can be accessed even when the vehicle is turned off or if the battery has been removed from the vehicle. The health score may be stored on a database connected to the EVIC system.

The EVIC system may utilize a machine learning model configured with artificial intelligence (AI) to monitor aspects such as charging times and temperature fluctuations of the battery, and offer recommendations for safe driving, such as changing speed, steering, and other handlings of the vehicle, as well as battery life recommendations, such as replacing malfunctioning battery cells. For example, the machine learning model may monitor (e.g., periodically receive as input) charge time and charge quantity of the battery. The machine learning model may make recommendations regarding how to improve battery life, such a charging schedule. The machine learning model may be trained on data associated with safe driving, battery cell management, other data associated with managing the conditions of a vehicle, or any combination thereof. In another example, the machine learning model may monitor the age of the battery, temperature fluctuations of the battery, the total miles driven while using the battery, and register such information on the blockchain network and/or a database connected to the EVIC system. The machine learning model may use this information to make recommendations associated with how to manage the battery life of the vehicle, such as how to prevent the battery from overheating.

The EVIC system may facilitate communication with other EVIC units, regardless of manufacturer, in proximity (e.g., with wireless communication range, within a threshold distance), forming a network to exchange real-time information about road conditions, hazards, obstacles, detours, and suggesting alternate routes, e.g., enhancing safety and efficiency in EV driving. The EVIC system may introduce an integrated app store, empowering drivers to personalize their EV experience by downloading and installing custom applications tailored to their specific needs.

The EVIC system may manage cell battery health by communicating with a Battery Management System (BMS). The BMS may detect cells or modules of the battery that are malfunctioning or otherwise impair the vehicle when in use. Such cells or modules of the battery may be taken offline and/or segmented away from the remaining cells or modules. The BMS may enable the EVIC system to reroute voltage and/or current around such cells or modules, thereby allowing the vehicle to operate in a reduced capacity mode. In real-time the reduced capacity mode may allow the vehicle to continue to operate and reach a safe destination. A spare cell or module may be activated by the BMS to replace the segmented malfunctioning cell or module. The BMS may communicate with the EVIC system to notify the user of the vehicle regarding the malfunctioning cell or module, any maintenance that may need to be performed, locations where the vehicle may be repaired, and/or any temporary solutions possible, such as activating a spare cell or module. The notification may be displayed on the user interface of the EVIC system via the LED display.

The EVIC system may communicate with a mobile application to allow users of the vehicle to communicate with the EVIC system. Through the mobile application, the user of the vehicle may run diagnostics associated with the vehicle. The EVIC system may receive a request for diagnostics from the user via the mobile application. The EVIC system may run diagnostics associated with the vehicle based on a request from the user. The EVIC system may run diagnostics associated with the vehicle (e.g., periodically, upon a trigger condition, at a predetermined time). The time and/or other conditions associated with running diagnostics may be set by the user via the mobile application. The EVIC system may send the user recommendations associated with how to better drive the vehicle based on various conditions, such as conditions associated with the battery of the vehicle. For example, if the diagnostics indicate the battery is degrading, such as age degradation, the EVIC system may recommend to the user to drive slower in order to increase the life span of the aging battery. The recommendations may be displayed to the user on the user interface and/or the mobile application.

The EVIC system may encompass an operating system, such as a Universal Electric Vehicle Operating System (UEVOS). The UEVOS may serve as an integrative middleware layer, designed for vehicles converted from internal combustion engines to electric powertrains. The UEVOS may manage electronic control units (ECUs) and interfaces with various vehicular sub-systems such as battery management systems (BMS), motor control units (MCU), and user interface modules. The UEVOS may include a modular architecture for adaptability across vehicle types, real-time monitoring capabilities, support for multiple vehicular communication protocols, an intuitive user interface, over-the-air (OTA) update capabilities, energy management algorithms, and/or robust data security measures. The UEVOS may be configured for versatility, interoperability, case of installation, data analytics, and eco-friendly drive modes, aiming to encourage the adoption of electric vehicles across various sectors.

The UEVOS may overcome one or more of a myriad of technical challenges. These technical challenges may include hardware heterogeneity, communication protocol compatibility, resource constraints, real-time processing requirements, concurrency management, data integrity in communication, software scalability, modularity, security measures, power management optimization, user interface design, and/or efficient over-the-air updates.

FIG. 1 shows an example of an environment 100 of a converted electric vehicle. The environment 100 may comprise a converted electric vehicle 110, an EVIC system 120, an electric motor 122, an electric battery 124, a network 130, a server 131, and a database 132, a user 140, or any combination thereof. In some scenarios, the converted electric vehicle 110 may comprise a gas (e.g., natural gas, gasoline, diesel, biodiesel, ethanol, propane) powered engine, hydrogen powered engine, or a combination thereof. The gas, hydrogen, and/or the like engines may be in addition to or as an alternative to the electric motor 122. Through primarily described herein for usage with an electric motor the EVIC system 120 may be configured to perform the same or similar actions for a gas and/or hydrogen powered engine, such as providing health scores, providing recommendations (e.g., based on machine learning models), displaying engine metrics (e.g., remaining fuel, engine metrics, etc), and/or the like. The EVIC system 120 may interface with the server 131 through the network 130, which may be configured for both wired and wireless communication, facilitating the secure exchange of data pertinent to the EVIC system 120. The server 131, equipped with requisite software to administer information to or from the EVIC system 120, may interact with the database 132 to retrieve and manage data.

The EVIC system 120 may comprise multiple components. For example, the EVIC system 120 may comprise a user interface, such as an LED display, a blockchain integration module, an AI module (e.g., machine learning module), a certified mechanics module, input/output ports, an operating system, an application store, and a cellular radio. The user interface may provide a central hub for delivering essential information to the user 140. For example, key metrics, such as vehicle speed, electric motor rotation and status, battery status, remaining battery life, and Bluetooth connectivity status, may be prominently displayed, ensuring a user (e.g., a driver, technician, or mechanic) has access to critical data.

The EVIC system 120 may comprise a blockchain integration module. The blockchain integration module may be fully integrated into the operating system of the EVIC system 120, a part of the EVIC system 120, or fully integrated into an external blockchain network. The blockchain integration module may record data on a blockchain, including total miles driven by the converted electric vehicle, information regarding conditions of the vehicle, such as temperature fluctuations and battery usage, information regarding certified parts installed during conversion or continued maintenance, and details of certified mechanics who have accessed the system. This blockchain-based approach may ensure transparency and accountability in the conversion process and continued maintenance. The blockchain integration module may be part of or associated with the operating system of the EVIC system 120.

The EVIC system 120 may comprise a certified mechanics module. The certified mechanics module may interact with the database 132 (e.g., by interfacing with the server 131 through the network 130) to retrieve and manage a database of certified mechanics. For example, only mechanics with proper certification may have access to the system, ensuring competence of professionals handling the installation of certified parts. The certified mechanics module may interact with the blockchain integration module or the blockchain network directly, in order to retrieve and manage a list of certified mechanics from the distributed ledger of the integrated blockchain. The certified mechanics module may be part of or associated with the operating system of the EVIC system 120.

The EVIC system 120 may comprise an artificial intelligence (AI) module. The AI module may implement machine learning within the EVIC system 120 by monitoring various aspects of the vehicle's operation, including such as charging times and temperature fluctuations of the battery, and offer recommendations for safe driving, such as changing speed, steering, and/or other handlings of the vehicle, as well as battery life recommendations, such as replacing malfunctioning battery cells. The AI module may facilitate communication with other nearby EVIC systems. This communication network may allow for real-time exchange of information about road conditions, hazards, or obstacles, enhancing driver safety and route planning. In other implementations, the AI module may be part of or exclusively located on an external server via a network, such as server 131 and network 130.

The converted electric vehicle may be converted from gasoline power to electrical power using a conversion kit. The conversion kit may comprise an electric motor, such as electric motor 122, and one or more batteries, such as battery 124. Once converted, the converted electric vehicle 110 may house an electric motor, such as electric motor 122, and one or more batteries, such as battery 124. The locations of the electric motor 122 and battery 124 within the converted electric vehicle 110 in FIG. 1 are examples, and in no way meant to be limiting. In practice, the electric motor 122 and battery 124 may be located anywhere within the chassis of the converted electric vehicle 110. The electric motor 122 may be any electric motor that is configured to be compatible with a vehicle that was converted from gasoline power to electric power. The EVIC system 120 may monitor the status, conditions, and functionality of the electric motor 122. The battery 124 may be any battery that is configured to be compatible with a vehicle that was converted from gasoline power to electric power. The EVIC system 120 may monitor the status, conditions, and functionality of the battery 124. The battery 124 may comprise various battery cells and/or modules. The battery 124 may comprise one or more spare battery cells and/or modules for use when another battery cell or module is malfunctioning or otherwise impairs the converted electric vehicle. The battery 124 may interface with a Battery Management System (BMS). The BMS may be part of the EVIC system 120 or may be coupled (e.g., communicatively coupled, electrically coupled) to the EVIC system 120. The BMS may be installed during conversion of the vehicle from gasoline power to electric power.

The EVIC system 120 may be configured to communicate with a vehicle control unit (e.g., in the converted electric vehicle 110) that connects to various hardware in the converted electric vehicle 110, such as the electric motor 122, the battery 124, and/or other sensors (e.g., tire pressure sensor, temperature sensor, etc.). The vehicle control unit may collect vehicle data from the various hardware of the converted electric vehicle and send the vehicle data to the EVIC system 120. Vehicle data may comprise battery information and/or vehicle status information. The battery information may comprise one or more of a battery usage history, a battery charging rate, a battery discharge rate, a battery operation pattern, or a change in battery behavior, a battery range, a battery voltage, a battery current, or any combination thereof. Vehicle status information may comprise a mileage of the converted electric vehicle, a condition of a component of the converted electric vehicle, a weather condition associated with the converted electric vehicle or one or more battery cells of the converted electric vehicle, or any combination thereof.

According to some aspects, the EVIC system 120 may comprise an application store which may enable drivers to download custom applications tailored to their preferences, further enhancing the versatility and functionality of the converted electric vehicle.

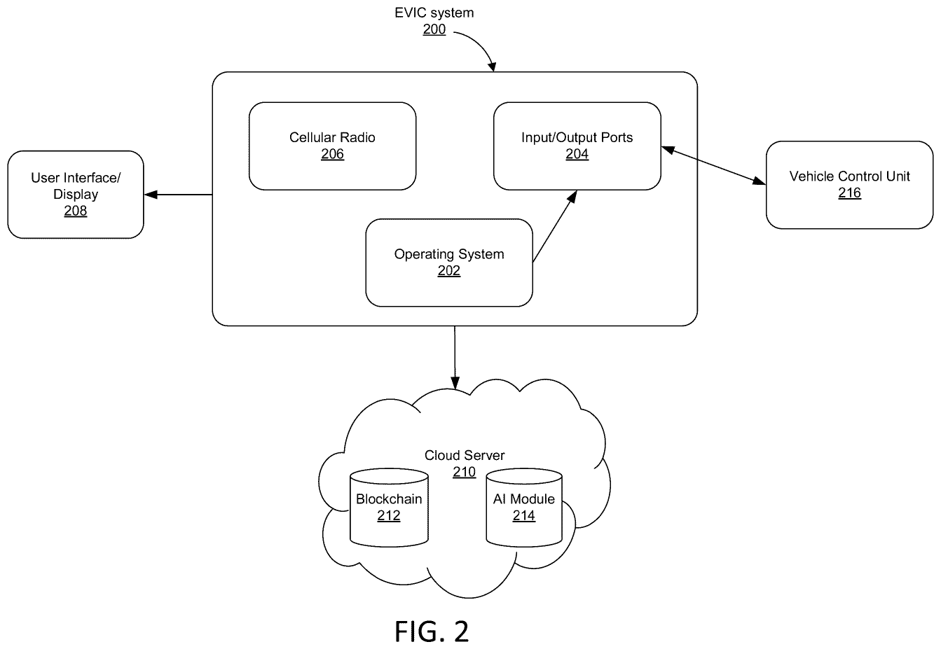

As illustrated in FIG. 2, an exemplary architecture for a EVIC system in a converted electric vehicle is disclosed. The EVIC system 200 may be housed in a converted electric vehicle, such as the EVIC system 120 and converted electric vehicle 110 in FIG. 1 The EVIC system 200 may comprise multiple components such as an operating system 202, input/output ports 204, a cellular radio 206, and/or other components described herein. The EVIC system 200 may connect to a vehicle control unit 216 via the input/output ports 204. The EVIC system 200 may comprise a user interface/display 208. The user interface/display 208 may be part of the EVIC system 200 or may be connected to the EVIC system 200. The user interface/display 208 may be part of connected to the cellular radio 206. The EVIC system 200 may be connected to a cloud server 210. The cloud server 210 may comprise one or more servers or devices such as the blockchain server 212, and the AI module 214. In some implementations, the blockchain server 212 and the AI module 214 may be fully or partially integrated into the EVIC system 200. The EVIC system 200 may connect to a cloud server 210 over a network, such as network 130 in FIG. 1.

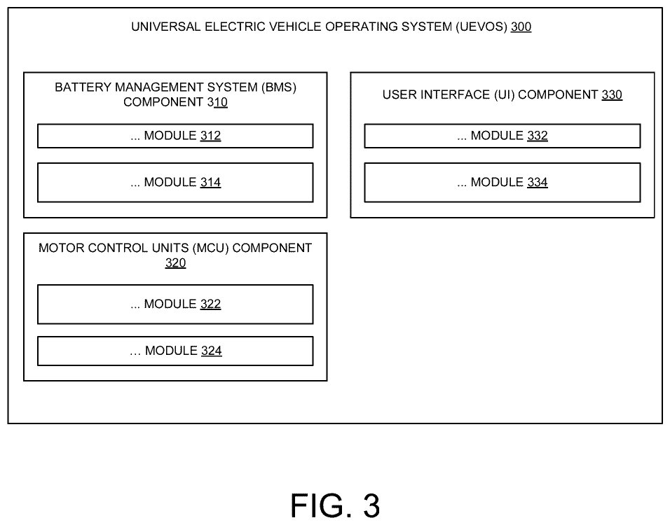

The operating system 202 may be a custom operating system designed for converted electric vehicles, such as the Universal Electric Vehicle Operating System (UEVOS) 300 in FIG. 3, or any other standard operating system. The operating system 202 may control the EVIC system 200. The operating system 202 may connect to the CAN bus of the car, read/monitor vehicle data, and send data to the user interface/display 208 for output to the user. The operating system 200 may be an integrative middleware layer responsible for managing the various components of the EVIC system 200.

The vehicle control unit 216 may collect vehicle data from the various hardware of the converted electric vehicle and send the vehicle data to the EVIC system 120. Vehicle data may comprise battery information and/or vehicle status information. The battery information may comprise one or more of a battery usage history, a battery charging rate, a battery discharge rate, a battery operation pattern, or a change in battery behavior, a battery range, a battery voltage, or a battery current. Vehicle status information may comprise a mileage of the converted electric vehicle, a condition of a component of the converted electric vehicle, or a weather condition associated with the converted electric vehicle or one or more battery cells of the converted electric vehicle. The vehicle control unit 216 may send this information to the EVIC system 200 via the input/output ports 204 for use by the operating system 202. The operating system 202 may display this information on the user/interface display 208.

The blockchain server 212 may utilize blockchain technology, enabling the secure registration of vital data, including total miles driven by the converted electric vehicle, a comprehensive inventory of certified parts used in the conversion process, and/or a verified list of certified mechanics involved in installations. For example, the EVIC system 200 may be configured to only allow mechanics with the requisite certifications access to the system to install certified parts, guarantecing high-quality standards in the conversion process and continued maintenance of the vehicle. To ensure certified parts are installed in the converted electric vehicle, the EVIC system 200 may cross-reference the mechanic and/or the parts to be installed via a digital distributed ledger housed on the blockchain server 212. This blockchain integration may ensure transparency and trust in the conversion process and continued maintenance of the vehicle, contributing to the safety and reliability of converted EVs. The real-time recording of data, such as the vehicle's odometer reading and the like, onto the digital distributed ledger of the blockchain server 212 may be utilized to prevent fraud and theft. The digital distributed ledger of the blockchain server 212 may be updated in real-time upon installation or replacement of components. The blockchain server 212 may be a custom blockchain network designed for electric vehicles or may be based on other blockchain networks known in the art.

The AI module 214 may utilize a machine learning model to monitor aspects such as charging times and temperature fluctuations of the battery, and offer recommendations for safe driving, such as changing speed, steering, and other handlings of the vehicle, as well as battery life recommendations, such as replacing malfunctioning battery cells. For example, the machine learning model may monitor charge time and charge quantity of the battery and in turn, make recommendations regarding how to improve battery life, such a charging schedule. The machine learning model may be trained on data associated with safe driving, battery cell management, other data associated with managing the conditions of a vehicle. In another example, the machine learning model may monitor the age of the battery, temperature fluctuations of the battery, the total miles driven while using the battery, and register such information on the blockchain server 212 and/or a database connected to the EVIC system 200. The machine learning model may use this information to make recommendations associated with how to manage the battery life of the vehicle, such as how to prevent the battery from overheating. Additionally, the EVIC system 200, via the AI module 214, may facilitate communication with other EVIC units, regardless of manufacturer, in proximity, forming a network to exchange real-time information about road conditions, hazards, obstacles, detours, and suggesting alternate routes, e.g., enhancing safety and efficiency in EV driving.

The EVIC system 200 may manage cell battery health by communicating with a Battery Management System (BMS). The BMS may be part of, integrated into, or external to the EVIC system 200. The BMS (e.g., or AI module 214 with data from the BMS) may detect cells or modules of the battery that are malfunctioning or otherwise impair the vehicle when in use. Such cells or modules of the battery may be taken offline and segmented away from the remaining cells or modules. The BMS may enable the EVIC system 200 to reroute voltage and/or current around such cells or modules, thereby allowing the vehicle to operate in a reduced capacity mode. In real-time the reduced capacity mode may allow the vehicle to continue to operate and reach a safe destination. A spare cell or module may be activated by the BMS to replace the segmented malfunctioning cell or module. The BMS may communicate with the EVIC system 200 to notify the user of the vehicle regarding the malfunctioning cell or module, any maintenance that may need to be performed, locations where the vehicle may be repaired, and/or any temporary solutions possible, such as activating a spare cell or module. The EVIC system 200 may output the notification to be displayed on the user interface/display 208.

As illustrated in FIG. 3, an exemplary Universal Electric Vehicle Operating System (UEVOS) 300 may provide an adaptive middleware layer responsible for managing electronic control units (ECUs), such as EVIC system 200 in FIG. 2, and interfacing with various vehicular sub-systems, including battery management systems (BMS), motor control units (MCU), and user interface modules. The UEVOS may be designed for converted electric vehicles.

The UEVOS 300 may function as an adaptive middleware layer, orchestrating the efficient management of electronic control units (ECUs) and facilitating seamless interaction with various vehicular sub-systems, including a Battery Management System (BMS) component 310, Motor Control Units (MCU) component 320, and user interface (UI) component 330, to create a comprehensive and integrated framework for electric vehicles.

The UEVOS 300 may be configured to address a number of technical challenges, including one or more of hardware heterogeneity, communication protocols, software scalability, security, power management, user interface design, and over-the-air updates. The UEVOS 300 may overcome these challenges by one or more of ensuring component compatibility, managing resource constraints, meeting real-time requirements, supporting multiple communication protocols, maintaining data integrity, ensuring code reusability and modularity, implementing robust security measures, optimizing power consumption, designing an intuitive user interface, and/or efficiently handling over-the-air updates.

The UEVOS 300 may incorporate one or more of these solutions via a multidisciplinary approach, involving expertise in embedded systems, software engineering, cybersecurity, and electrical engineering. By addressing these challenges, the UEVOS 300 may enable the transition from internal combustion engines to electric powertrains across diverse vehicle types, driving the advancement of electric vehicle technology.

The BMS component 310 may oversee the health and performance of the electric vehicle's battery. For example, the BMS component 310 may monitor key metrics, such as battery state-of-charge, temperature, and overall condition. The BMS component 310 may ensure that the battery operates within safe parameters. The BMS component 310 may optimizes the battery's usage for enhanced longevity and efficiency. Real-time monitoring capabilities of the BMS component 310 may be integrated into (e.g., or communicated to) the UEVOS 300, providing essential data to the UEVOS 300 for informed decision-making, such as rerouting power to spare battery cells or modules in the event of one or more battery cells or modules malfunctioning or otherwise impairing the converted electric vehicle.

The MCU component 320 may govern the operation of the electric motor, managing power delivery and torque control. The MCU component 320 may optimize motor performance, enable regenerative braking, and ensure smooth and efficient power delivery to the wheels. Accordingly, the MCU component 320 may further contribute to the overall efficiency and performance of the electric vehicle.

The UI module component 330 within UEVOS 300 may enhance the driver's experience. It may provide a user-friendly and intuitive interface for the vehicle's occupants. The UI module component 330 may offer a capacitive touch screen display that presents critical information to the driver, such as vehicle speed, battery charge level, range estimation, and diagnostic data. This user-friendly interface may ensure that essential vehicle information is easily accessible to the driver, enhancing safety and user satisfaction. The UI module component 330 may comprise the user interface/display 208 in FIG. 2.

The UEVOS 300 may provide numerous core features that may be utilized by an ECU, such as EVIC system 200 in FIG. 2. For example, the UEVOS 300 may have modular architecture to facilitate adaptability across a range of vehicle types, such as private passenger cars and commercial freight vehicles. The UEVOS 300 may implement real-time operating system functionality, such as battery state-of-charge monitoring, fault detection, and thermal management. The UEVOS 300 may be enable comprehensive vehicular communication via a CAN, local interconnect networks (LIN), and/or ethernet for automotive vehicles. The UEVOS 300 may implement a machine learning model, such as the AI module 214 in FIG. 2, to allow various features, such as remote over-the-air software updates to ensure the system remains current with advancements in electric vehicle technology, optimal energy utilization, and/or regenerative braking. The UEVOS 300 may incorporate advanced encryption standards and secure boot mechanism to protect against unauthorized access and cyber threats.

The UEVOS 300 may be designed to ensure seamless integration with existing automotive ECUs and/or custom ECUs, such as EVIC system 200 in FIG. 2, thus encouraging conversion of vehicles from gasoline power to electric power. The UEVOS 300 may be engineered for minimal hardware dependencies, allowing for streamlined installation processes. The UEVOS 300 may be configured to perform data logging and/or analytics analytics, assisting in predictive maintenance and long-term vehicle health monitoring via machine learning models, such as AI module 214 in FIG. 2. The UEVOS 300 may incorporate various driving modes focused on maximizing energy efficiency and minimizing environmental impact.

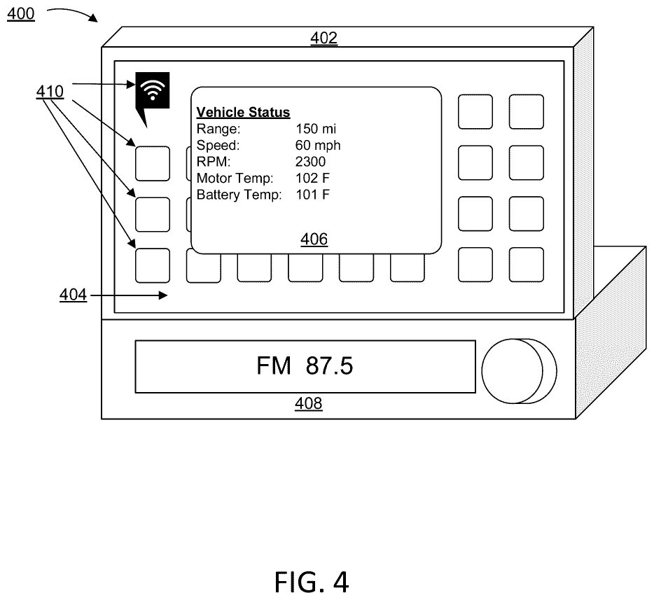

As illustrated in FIG. 4, an exemplary user interface display 400, which may be installed in a converted electric vehicle, such as converted electric vehicle 110 in FIG. 1, may display various important information to a user of a converted electric vehicle, as indicated in Vehicle Status heads-up-display (HUD) 406 overlayed on the screen 404. The user interface display 400 may comprise an LED display 402 that is operatively connected to a cellular radio 408 and installed in the center console of an electric vehicle. In some implementations, the user interface display 400 may comprise just the LED display 402 and forgo the traditional cellular radio 408. The user interface display 400 may run an operating system, such as the custom UEVOS 300 in FIG. 3, or any other compatible operating system. The user interface display 400 may display various icons 410, such as internet connection functionality, applications, and other features of the operating system deployed. One such feature may be the Vehicle Status HUD 406. A user may click on an icon, such as icons 410, to view the Vehicle Status HUD 406. The Vehicle Status HUD 406 may display to the user various information associated with the converted electric vehicle, such as the distance range until the vehicle needs to be recharged, the speed of the vehicle, the revolutions-per-minute (RPM) of the electric motor, the motor temperature, the battery temperature, and other vehicle information disclosed herein.

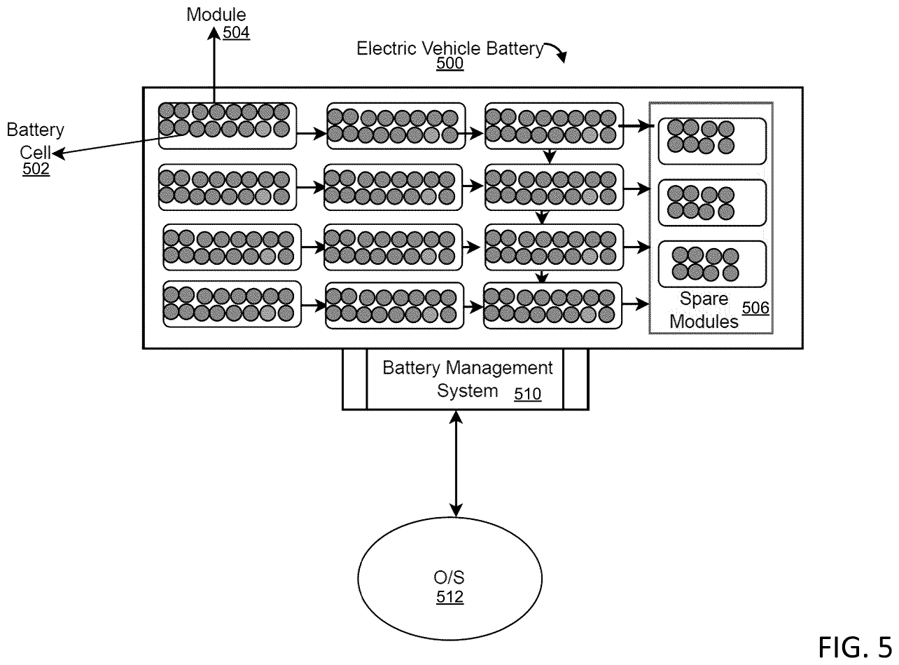

As illustrated in FIG. 5, an exemplary battery management system (BMS) 510 is devised for managing an electric vehicle battery (EVB), such as EVB 500, of a converted electric vehicle, such as converted electric vehicle 110 in FIG. 1. The EVB 500 may comprise multiple modules 504, wherein each module may comprise multiple battery cells, such as battery cell 502. The EVB 500 may also contain spare modules 506, which also comprise spare battery cells.

The BMS 510 may be integrated into a converted electric vehicle via an operating system of an EVIC system, such as O/S 512. The O/S 512 may be a custom operating system developed for converted electric vehicles, such as UEVOS 300 in FIG. 3. The BMS 510 may detect cells or modules of the EVB 500 that are malfunctioning or would otherwise impair the vehicle when in use. Such cells or modules of the EVB 500 may be taken offline and segmented away from the remaining cells or modules. The BMS 510 may enable the O/S 512 to reroute voltage around such cells or modules, thereby allowing the vehicle to operate in a reduced capacity mode. In real-time the reduced capacity mode may allow the vehicle to continue to operate and reach a safe destination. A spare cell or module, such as spare modules 506, may be activated by the BMS 510 to replace the segmented malfunctioning cell or module. The BMS 510 may communicate with the O/S 512 to notify the user of the vehicle regarding the malfunctioning cell or module, any maintenance that may need to be performed, locations where the vehicle may be repaired, and/or any temporary solutions possible, such as activating a spare cell or module. The O/S 512 may send a notification to be displayed on the user interface or display of the EVIC system for the user to view.

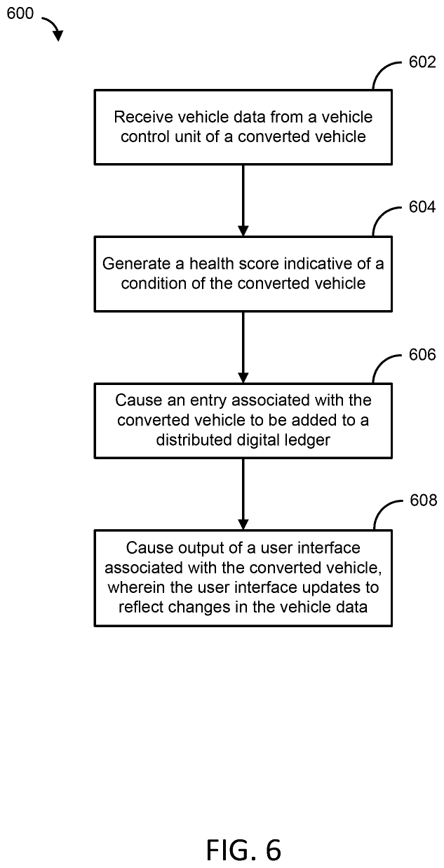

FIG. 6 shows an example method. The method 600 may comprise a computer implemented method for providing a service (e.g., a vehicle management service). A system and/or computing environment, such as the system 100 of FIG. 1 and/or the computing environment of FIG. 6, may be configured to perform the method 600. The method 600 may be performed in connection with the system illustrated in FIG. 1. Any step or combination of steps of the method 600 may be performed by a computing device, vehicle controller, network device, network node, server device, and/or user device, such as any of the devices shown in FIG. 1 and/or FIG. 2. Any of the features of other methods described herein (e.g., as shown in FIG. 3-5 or otherwise) may be combined with any of the features and/or steps of the method 600 of FIG. 6.

At step 602, vehicle data from a vehicle control unit of a converted electric vehicle may be received. Vehicle data may comprise battery information and/or vehicle status information. The battery information may comprise one or more of a battery usage history, a battery charging rate, a battery discharge rate, a battery operation pattern, or a change in battery behavior, a battery range, a battery voltage, or a battery current. Vehicle status information may comprise a mileage of the converted electric vehicle, a condition of a component of the converted electric vehicle, or a weather condition associated with the converted electric vehicle or one or more battery cells of the converted electric vehicle. The vehicle data from a vehicle control unit of a converted electric vehicle may be received by a computing device. The converted electric vehicle may be converted from gasoline power to electrical power using a conversion kit. The computing device may comprise an operating system configured for vehicles converted from gasoline power to electrical power.

At step 604, a health score indicative of a condition of the converted electric vehicle may be generated. The health score indicative of a condition of the converted electric vehicle may be generated based on the vehicle data. The health score may be based on battery information associated with one or more battery cells used to generate the electric power. The battery information may comprise one or more of a battery usage history, a battery charging rate, a battery discharge rate, a battery operation pattern, or a change in battery behavior, a battery range, a battery voltage, or a battery current.

The health score may be further based on one or more of: a mileage of the converted electric vehicle, a condition of a component of the converted electric vehicle, or a weather condition associated with the converted electric vehicle or one or more battery cells of the converted electric vehicle. The health score may be a score on a scale (e.g., sliding scale) from zero to one hundred, with zero being completely unhealth and one hundred being fully healthy. The health score may be based on a combination of any of the following factors: total mileage, condition of battery cells, total number of battery cell charges, and condition of components. The health score may be calculated as a linear combination of cach of the factors. One or more of the factors may be weighted. The weighting may be different for each factor, or the same. The weighting may allow for a total score to be within the scaled range from zero to one hundred. Lower mileage, healthier cells, lower number of charges, and/or better condition (e.g., age, associated mileage, sensor results) of components may result in a better health score. The lower the mileage on a vehicle and the healthier the cells the higher the score. For example, if a converted electric vehicle has a total mileage of under 500 miles with less than 10 charges of 100% and have all the components indicated as in good condition, with all the battery cells in a healthy condition (e.g., functioning in with certain thresholds of current, voltage, power, age, etc.), then the health score may be as high as 100%. However, if the total mileage is at 50,000 miles with total number of charges up to 100% being between 400 to 500, then the health score could drop to 60%, for example.

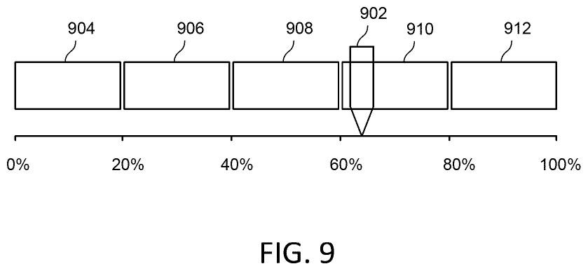

As just one example, the health score may be represented as a number from 0 to 100. The health score may be represented as an indicator 902 (e.g., arrow) on scale as shown in FIG. 9. The health score may be represented as a color. For example, each of the different blocks in FIG. 9 may represent a color. A first block 904 (e.g., from 0 to 19) may be represented with a red color. A second block 906 (e.g., from 20 to 39) may be represented with an orange color. A third block 908 (e.g., from 40 to 59) may be represented with a yellow color. A fourth block 910 (e.g., from 60 to 79) may be represented with a light green color. A fifth block 912 (e.g., from 80 to 100) may be represented with a dark green color.

At step 606, an entry associated with the converted electric vehicle may be caused to be added to a distributed digital ledger. The entry may be caused to be added by the computing device. The entry may be caused to be added based on the vehicle data. The entry associated with the converted electric vehicle added to the distributed digital ledger may comprise one or more of mileage information, vehicle part information, or maintenance information associated with the converted electric vehicle.

At step 608, output of a user interface associated with the converted electric vehicle may be caused. The output of a user interface associated with the converted electric vehicle may be caused by the computing device. The user interface may update to reflect changes in the vehicle data and may be configured to display a speed of the converted electric vehicle, the health score, and battery information of the converted electric vehicle. The user interface may be output by the operating system. The user interface may be configured to display the recommendation.

The method may comprise generating a recommendation associated with the converted electric vehicle. The recommendation may comprise a recommendation to update, based on one or more conditions of at least one battery cell, a battery configuration of the converted electric vehicle. The recommendation may comprise a recommendation to change, based on one or more conditions associated with the converted electric vehicle, a speed of the converted electric vehicle. The recommendation may comprise a recommendation to change a route of the converted electric vehicle. The recommendation may comprise a recommendation to replace, based on one or more conditions of one or more components of the converted electric vehicle, at least one of the one or more components of the converted electric vehicle.

The generating the recommendation may comprise inputting data associated with the converted electric vehicle to a machine learning model configured to output the recommendation. The machine learning model may comprise a supervised machine learning model, an unsupervised machine learning model, or a combination thereof. The machine learning model may comprise a plurality of machine learning models configured to provide a combined result. The machine learning model may comprise a logistic regression model, support vector machine, Bayes algorithm model, decision tree, linear regression, k nearest neighbor model, random forest model, boosting algorithm, K-means algorithm, hierarchical clustering algorithm, a neural network, or a combination thereof. The machine learning model may be trained based on training data associated with a plurality of vehicles (e.g., converted electric vehicles, electric vehicles, gas powered vehicles). The training data may comprise sensor data, battery data (e.g., battery history, voltage, current, power output, charge state, number of battery cells, state of cach battery cell), maintenance data (e.g., parts replaced, service visits, repairs), usage and driving behavior data, location data, infotainment and connectivity data, engine performance data, and/or the like.

The data input into the machine learning model may comprise data from the converted electric vehicle (e.g., data from the operating system), such as sensor data, mileage data, electrical data (e.g., power data, electrical response to user input, current, voltage, history thereof, trends), temperature data, vehicle indicator data (e.g., check engine light), speed data, acceleration data, mileage, usage and driving behavior data, location data, infotainment and connectivity data, engine performance data, or any combination thereof. An example recommendation may comprise an indication that a bad cell is detected, a recommendation to modify a configuration (e.g., battery cell configuration, rerouting around the bad cell) of the converted electric vehicle, a recommendation to reroute the converted electric vehicle to a service station (e.g., or other store, parts dealer), a recommendation to schedule a visit with a service station, a recommendation to send a request (e.g., or call) for a mobile service vehicle come to a location or destination of the converted electric vehicle (e.g., to address a problem with the converted electric vehicle), or any combination thereof.

The method may comprise updating a battery configuration of the converted electric vehicle based on one or more of disabling one or more battery cells, enabling one or more battery cells, sending a command to battery management system to change the battery configuration, causing a circuit element to activate or deactivate in a battery, or rerouting battery circuitry to exclude a battery cell from being used to provide the electrical power.

The method may comprise communicating, by the computing device, operational information with an additional vehicle within communication range of the converted electric vehicle. The operational information may comprise road conditions, location (e.g., GPS location, location within a road coordinate system), distance from the additional vehicle, road closures, traffic speed, The additional vehicle may use the operational information to modify the operation of the additional vehicle. Modifying the operation of the additional vehicle may comprise changing lanes, changing speed, moving to avoid an obstacle, rerouting, and/or the like.

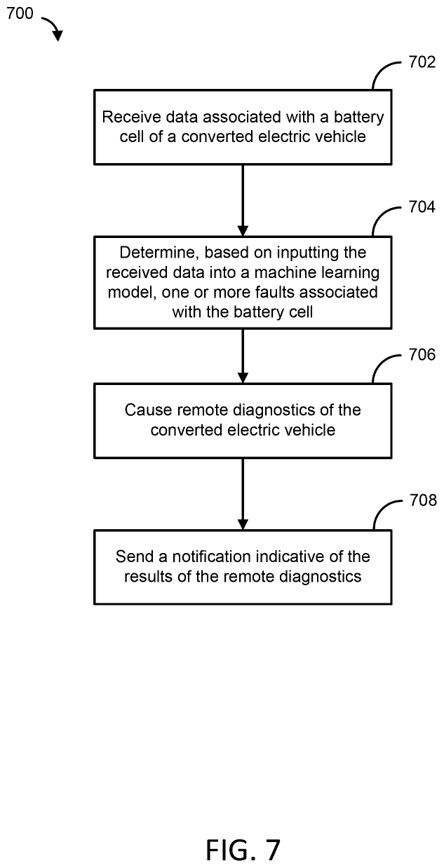

An exemplary method 700 is illustrated in FIG. 7. The method 700 may comprise a plurality of steps. For example, the method 700 may manage battery cell health in a converted EV. The method 700 may comprise receiving data from a BMS (Battery Management System). The EVIC system may receive data from the BMS related to a specific battery cell. For instance, at step 702, the EVIC system may receive information on the temperature of a battery cell. For example, the BMS may transmit a temperature reading of 40° C. for a particular battery cell to the EVIC system.

At step 704, the EVIC system may determine faults based on an AI model (e.g., machine learning model, neural network) by analyzing received data and determining if there is a fault or issue with the battery cell. This determination may be based on factors such as temperature exceeding a certain threshold. The AI model may be configured to associate combinations, patterns, values, and/or the like of data (e.g., temperature data, current data, voltage date, acceleration data, charge data, discharge data, and/or the like), with one or more potential problems. For example, the AI model may detect that the temperature of the battery cell has exceeded a safe limit, indicating a fault. If a fault is identified, the EVIC system may take corrective action by activating a secondary battery cell to replace a problematic one. This action may involve rerouting power to bypass the problematic cell. For example, the EVIC system may reroute power from the overheating battery cell to a backup cell, ensuring continuous vehicle operation. Once the second battery cell is activated, the EVIC system allows the converted EV to operate in a limited mode to ensure safety and continued functionality. For example, the EVIC system may enable the vehicle to operate at reduced speed and power to reach a safe location for repairs.

At step 706, the EVIC system may enable remote diagnostics by allowing remote diagnostics of the converted EV through a mobile application that interfaces with the EVIC system. Diagnostic data, including battery health, current range, and motor performance, may be provided to the user. For example, a mobile app may connect to the EVIC system, displaying real-time data on battery health, current range, and/or motor performance to a driver's smartphone.

The EVIC system may utilize generative AI to enhance its capabilities. Examples of enhanced functionality may include voice commands to control various aspects of the vehicle and the automatic rerouting of power around problematic battery cells when no driver response is detected. For example, the EVIC system may use generative AI to understand voice commands from the driver and adjust vehicle settings accordingly, providing a hands-free driving experience.

At step 708, the EVIC system may send a notification indicative of the results of the remote diagnostics to a user interface for display. The user interface may receive the notification and prompt the user to view the results of the remote diagnostics. The user interface may display the results to the user.

The EVIC system may be provided with a conversion kit to convert a vehicle from gasoline power to electric power. The EVIC system may be connected to a Vehicle Control Unit (VCU) of a converted electric vehicle. For example, an EV conversion kit is sold with the EVIC system included, which can be installed in any gasoline-powered vehicle to convert it into an electric vehicle.

The EVIC system may employ a custom operating system to read data from the VCU of the converted electric vehicle. This custom OS may enable seamless communication and control. For example, the EVIC system may use a proprietary operating system to interface with the VCU and gather data about the vehicle's performance. The EVIC system may display crucial vehicle information on a user interface, including speed, electric motor status, remaining battery life, etc. For example, the EVIC system's dashboard display may show the vehicle's current speed, battery status, and whether the electric motor is active or not.

The EVIC system may connect to a blockchain network to record essential data, such as total miles driven, information about certified parts, and details of certified mechanics who have accessed the system. For example, every time the vehicle is driven, the blockchain records the total miles traveled, ensuring an accurate record for maintenance purposes.

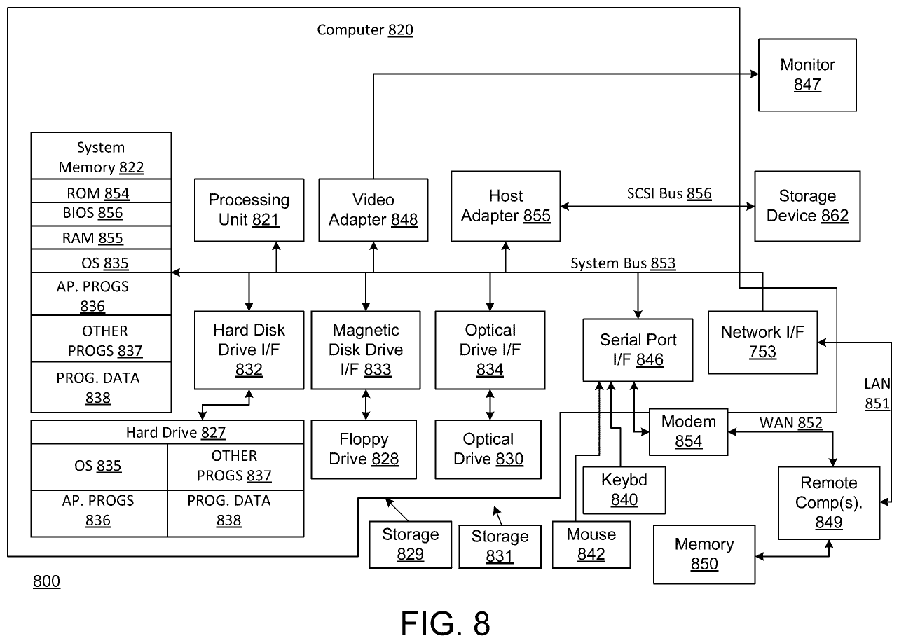

FIG. 8 and the following discussion are intended to provide a brief general description of a suitable computing environment in which the methods and systems disclosed herein, or portions thereof may be implemented. Although not required, the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips, or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices. It is contemplated that the disclosed steps associated with different Figures may be combined. Also, the steps may be distributed over multiple devices or performed primarily on one device.

FIG. 8 is a block diagram representing a computer system 800 in which aspects of the methods and systems disclosed herein and/or portions thereof may be incorporated. As shown, the exemplary general purpose computing system includes a computer 820 or the like, including a processing unit 821, a system memory 822, and a system bus 823 that couples various system components including the system memory to the processing unit 821. The system bus 823 may be any of several types of bus structures including a memory bus or memory controller, a peripheral bus, and a local bus using any of a variety of bus architectures. The system memory includes read-only memory (ROM) 824 and random-access memory (RAM) 825. A basic input/output system 826 (BIOS), containing the basic routines that help to transfer information between elements within the computer 820, such as during start-up, is stored in ROM 824.

The computer 820 may further include a hard disk drive 827 for reading from and writing to a hard disk (not shown), a magnetic disk drive 828 for reading from or writing to a removable magnetic disk 829, and an optical disk drive 830 for reading from or writing to a removable optical disk 831 such as a CD-ROM or other optical media. The hard disk drive 827, magnetic disk drive 828, and optical disk drive 830 are connected to the system bus 823 by a hard disk drive interface 832, a magnetic disk drive interface 833, and an optical drive interface 834, respectively. The drives and their associated computer-readable media provide non-volatile storage of computer readable instructions, data structures, program modules and other data for the computer 820. As described herein, computer-readable media is a tangible, physical, and concrete article of manufacture and thus not a signal per se.

Although the exemplary environment described herein employs a hard disk, a removable magnetic disk 829, and a removable optical disk 831, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random-access memory (RAM), a read-only memory (ROM), and the like.

A number of program modules may be stored on the hard disk, magnetic disk 829, optical disk 831, ROM 824 or RAM 825, including an operating system 835, one or more application programs 836, other program modules 837 and program data 838. A user may enter commands and information into the computer 820 through input devices such as a keyboard 840 and pointing device 842. Other input devices (not shown) may include a microphone, joystick, game pad, satellite disk, scanner, or the like. These and other input devices are often connected to the processing unit 821 through a serial port interface 846 that is coupled to the system bus, but may be connected by other interfaces, such as a parallel port, game port, or universal serial bus (USB). A monitor 847 or other type of display device is also connected to the system bus 823 via an interface, such as a video adapter 848. In addition to the monitor 847, a computer may include other peripheral output devices (not shown), such as speakers and printers. The exemplary system of FIG. 8 also includes a host adapter 855, a Small Computer System Interface (SCSI) bus 856, and an external storage device 862 connected to the SCSI bus 856.

The computer 820 may operate in a networked environment using logical connections to one or more remote computers, such as a remote computer 849. The remote computer 849 may be a personal computer, a server, a router, a network PC, a peer device or other common network node, and may include many or all of the elements described above relative to the computer 820, although only a memory storage device 850 has been illustrated in FIG. 8. The logical connections depicted in FIG. 8 include a local area network (LAN) 851 and a wide area network (WAN) 852. Such networking environments are commonplace in offices, enterprise-wide computer networks, intranets, and the Internet.

When used in a LAN networking environment, the computer 820 is connected to the LAN 851 through a network interface or adapter 853. When used in a WAN networking environment, the computer 820 may include a modem 854 or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing a communications link between the computers may be used.

Computer 820 may include a variety of computer readable storage media. Computer readable storage media can be any available media that can be accessed by computer 820 and includes both volatile and nonvolatile media, removable and non-removable media. By way of example, and not limitation, computer readable media may comprise computer storage media and communication media. Computer storage media include both volatile and nonvolatile, removable, and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 820. Combinations of any of the above should also be included within the scope of computer readable media that may be used to store source code for implementing the methods and systems described herein. Any combination of the features or elements disclosed herein may be used in one or more examples.

What is claimed:

1. A method comprising:
receiving, by a computing device, vehicle data from a vehicle control unit of a converted vehicle, wherein the converted vehicle is converted from gasoline power to electrical power using a conversion kit;
generating, based on the vehicle data, a health score indicative of a condition of the converted vehicle, wherein the health score is based on battery information associated with one or more battery cells used to generate the electric power;
causing, by the computing device and based on the vehicle data, an entry associated with the converted vehicle to be added to a distributed digital ledger; and
causing, by the computing device, output of a user interface associated with the converted vehicle, wherein the user interface updates to reflect changes in the vehicle data and is configured to display a speed of the converted vehicle, the health score, and battery information of the converted vehicle.

2. The method of claim 1, wherein the entry associated with the converted vehicle added to the distributed digital ledger comprises one or more of mileage information, vehicle part information, or maintenance information associated with the converted vehicle.

3. The method of claim 1, wherein the health score is further based on one or more of:
a mileage of the converted vehicle,
a condition of a component of the converted vehicle, or
a weather condition associated with the converted vehicle or one or more battery cells of the converted vehicle.

4. The method of claim 1, wherein the computing device comprises an operating system configured for vehicles converted from gasoline power to electrical power, wherein the user interface is output by the operating system.

5. The method of claim 1, further comprising generating a recommendation associated with the converted vehicle, wherein the user interface is configured to display the recommendation.

6. The method of claim 5, wherein the recommendation comprises a recommendation to one or more of:
update, based on one or more conditions of at least one battery cell, a battery configuration of the converted vehicle,
change, based on one or more conditions associated with the converted vehicle, a speed of the converted vehicle,
change a route of the converted vehicle, or
replace, based on one or more conditions of one or more components of the converted vehicle, at least one of the one or more components of the converted vehicle.

7. The method of claim 5, wherein the generating the recommendation comprises inputting data associated with the converted vehicle to a machine learning model configured to output the recommendation.

8. The method of claim 1, further comprising updating a battery configuration of the converted vehicle based on one or more of disabling one or more battery cells, enabling one or more battery cells, sending a command to battery management system to change the battery configuration, causing a circuit element to activate or deactivate in a battery, or rerouting battery circuitry to exclude a battery cell from being used to provide the electrical power.

9. The method of claim 1, further comprising communicating, by the computing device, operational information with an additional vehicle within communication range of the converted vehicle.

10. The method of claim 1, wherein the battery information comprises one or more of a battery usage history, a battery charging rate, a battery discharge rate, a battery operation pattern, or a change in battery behavior, a battery range, a battery voltage, or a battery current.

11. A device comprising:
one or more processors; and
memory storing instructions that, when executed by the one or more processors, cause the device to:
receive vehicle data from a vehicle control unit of a converted vehicle, wherein the converted vehicle is converted from gasoline power to electrical power using a conversion kit;
generate, based on the vehicle data, a health score indicative of a condition of the converted vehicle, wherein the health score is based on battery information associated with one or more battery cells used to generate the electric power;
cause, based on the vehicle data, an entry associated with the converted vehicle to be added to a distributed digital ledger; and
cause output of a user interface associated with the converted vehicle, wherein the user interface updates to reflect changes in the vehicle data and is configured to display a speed of the converted vehicle, the health score, and battery information of the converted vehicle.

12. The device of claim 11, wherein the entry associated with the converted vehicle added to the distributed digital ledger comprises one or more of mileage information, vehicle part information, or maintenance information associated with the converted vehicle.

13. The device of claim 11, wherein the health score is further based on one or more of:
a mileage of the converted vehicle,
a condition of a component of the converted vehicle, or
a weather condition associated with the converted vehicle or one or more battery cells of the converted vehicle.

14. The device of claim 11, wherein the device comprises an operating system configured for vehicles converted from gasoline power to electrical power, wherein the user interface is output by the operating system.

15. The device of claim 11, wherein the instructions, when executed by the one or more processors, further cause the device to generate a recommendation associated with the converted vehicle, wherein the user interface is configured to display the recommendation.

16. The device of claim 15, wherein the recommendation comprises a recommendation to one or more of:
update, based on one or more conditions of at least one battery cell, a battery configuration of the converted vehicle,
change, based on one or more conditions associated with the converted vehicle, a speed of the converted vehicle,
change a route of the converted vehicle, or
replace, based on one or more conditions of one or more components of the converted vehicle, at least one of the one or more components of the converted vehicle.

17. The device of claim 15, wherein the instructions that, when executed by the one or more processors, cause the device to generate the recommendation comprises instructions that, when executed by the one or more processors, cause the device to input data associated with the converted vehicle to a machine learning model configured to output the recommendation.

18. The device of claim 11, wherein the instructions, when executed by the one or more processors, further cause the device to update a battery configuration of the converted vehicle based on one or more of disable one or more battery cells, enable one or more battery cells, send a command to battery management system to change the battery configuration, cause a circuit element to activate or deactivate in a battery, or reroute battery circuitry to exclude a battery cell from being used to provide the electrical power.

19. The device of claim 11, wherein the battery information comprises one or more of a battery usage history, a battery charging rate, a battery discharge rate, a battery operation pattern, or a change in battery behavior, a battery range, a battery voltage, or a battery current.

20. A system comprising:
a converted vehicle comprising one or more components and a vehicle control unit configured collect vehicle data associated with the one or more components, wherein the converted vehicle is converted from gasoline power to electrical power using a conversion kit; and
a computing device configured to:
receive the vehicle data from the vehicle control unit of the converted vehicle;
generate, based on the vehicle data, a health score indicative of a condition of the converted vehicle, wherein the health score is based on battery information associated with one or more battery cells used to generate the electric power;
cause, based on the vehicle data, an entry associated with the converted vehicle to be added to a distributed digital ledger; and
cause output of a user interface associated with the converted vehicle, wherein the user interface updates to reflect changes in the vehicle data and is configured to display a speed of the converted vehicle, the health score, and battery information of the converted vehicle.
